(19) United States
(12) Patent Application Publication
(10) Pub. No.: US 2003/0172027 A1
(43) Pub. Date: Sep. 11, 2003

(54) Method for conducting a credit transaction using biometric information

(76) Inventor: Walter G. Scott, North Palm Beach, FL (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/284,453

(22) Filed: Oct. 31, 2002

Related U.S. Application Data
(63) Continuation-in-part of application No. 09/815,250, filed on Mar. 23, 2001.
(60) Provisional application No. 60/330,794, filed on Oct. 31, 2001.

(51) Int. Cl. G06F 17/60

(52) U.S. Cl. 705/39

(57) ABSTRACT

Biometric information is obtained from an individual during a credit transaction and used to verify the identity of the individual prior to completing the transaction in order to prevent the unauthorized use of the credit account. The print identification data is obtained from the individual using an identification device and sent to an identity verification service for a determination about the individual's identity. The credit account number is obtained from the individual and sent to a payment approval service.

### RELATED APPLICATIONS

This application is a continuation-in-part of U.S. application Ser. No. 09/815,250, filed Mar. 23, 2001, and it claims the benefit of U.S. Provisional Application No. 60/330,794, filed Oct. 31, 2001, each of which is incorporated herein by reference in its entirety.

### FIELD OF THE INVENTION

The present invention relates generally to credit transactions. More particularly, it relates to using an identification device for obtaining biometric information, such as a fingerprint, and using the obtained information to recognize and/or identify an individual during a credit transaction.

### BACKGROUND OF THE INVENTION

Credit card fraud is a serious problem. Every year, a large number of credit cards are lost or stolen and used by unauthorized individuals to make fraudulent purchases before the lost or stolen credit card can be cancelled.

In the known methods for conducting credit card purchases, security is based on a comparison of a signature written on the back of a credit card to a signature written at the point of sale by the individual wishing to use the credit card. The comparison of the two signatures, if performed at all, is performed by a sales clerk. Typically, this sales clerk has no formal training in how to detect forged signatures. Thus, the known methods for conducting credit card purchases are vulnerable to fraud.

The use of biometrics provides an opportunity to address the security concerns associated with credit cards and credit card fraud. Biometrics are a group of technologies that provide a high level of security. Fingerprint capture and recognition is an important biometric technology. Law enforcement, banking, voting, and other industries increasingly rely upon fingerprints as a biometric to recognize or verify identity. See, Biometrics Explained, v. 2.0, G. Roethenbaugh, International Computer Society Assn. Carlisle, Pa. 1998, pages 1-34 (incorporated herein by reference in its entirety). Generally, a biometric is a measurable, physical characteristic or personal behavior trait used to recognize the identity, or verify the claimed identity, of a person who has a biometric reference template (e.g., data that represents a biometric measurement) on file.

What is needed is a method for conducting credit transactions that enables the use of biometric authentication. This method should make credit transactions, secure, adaptable, and cost effective.

### BRIEF SUMMARY OF THE INVENTION

The present invention provides an identification device and applications thereof. In embodiments, the identification device is a low-cost, hand-held, easy to use, ubiquitous device that uniquely identifies a person using biometric features. These biometric features are captured, transmitted, processed and/or stored as biometric information or data.

In embodiments, the identification device is used to conduct secure credit transactions. Biometric information is obtained from an individual during a credit transaction and used to verify the identity of the individual prior to completing the transaction. The identification device is used to securely obtain and transmit the biometric information, and to securely store and transmit credit information such as, for example, a credit card number or a credit account number. The enhanced security features of the invention prevent unauthorized access to and use of the credit card number or the credit account number.

In embodiments, the biometric information comprises print or print identification data for the individual wanting to conduct the credit transaction (e.g., make a purchase using credit). The print identification data is obtained from the individual using biometric capture features of the identification device. In embodiments of the invention, the print identification data obtained from the individual can include, for example, hand or palm prints, fingerprints and/or thumb prints. This print identification data can be captured, transmitted and/or stored, for example, as minutiae data, a bit map, grayscale image data, 10-pixel-per-millimeter bilevel data and/or 20-pixel-per-millimeter bilevel data. The print identification data is received at a transaction terminal from the identification device for processing.

The print identification data received at the transaction terminal is sent to an identity verification service. The identity verification service compares and/or matches the print identification data to data stored in a database to make a determination about the individual's identity. After making a determination, the identity verification service sends its result (verification data) either to the transaction terminal or to a payment approval service or to both.

In embodiments, a credit card number or credit account number to be used to conduct the credit transaction is received at the transaction terminal from the identification device. The credit account number received at the transaction terminal and information about the transaction (e.g., purchase information) are sent to a payment approval service. The payment approval service processes the received credit account number and the received transaction information and makes a determination about the individual's authorization to conduct the transaction. The result of the payment approve service's determination (authorization data) is sent to the transaction terminal. The operator of the transaction terminal makes a determination whether to complete the transaction based on the data received at the transaction terminal. In embodiments, the credit card number or credit account number stored in the identification device can be accessed only by an authorized user, and only after the authorized user's identity has been verified using the biometric capture features of the identification device.

In embodiments, the print identification data is obtained from the individual using a wireless transceiver biometric device. In embodiments, this device can obtain biometric data in addition to hand or palm prints, fingerprints and/or thumb prints.

In one embodiment of the invention, print identification data for an individual wanting to make a purchase is received by an identity verification service from a merchant. This print identification data and credit account data are obtained by the merchant from the individual using a wireless transceiver device. The received print identification data is compared to print identification data stored in a database. In this embodiment, the results of the comparison are sent to a credit service in order to permit the credit service to make a determination about the individual's authorization to use a particular account. The results of the comparison may also be sent to the merchant in order to permit the merchant to make a determination about whether to complete the purchase.

In another embodiment, data about the identity of an individual wanting to make a purchase from a merchant is received by a credit service from an identity verification service. The received data is based, in part, on a comparison of print identification data for the individual to print identification data stored in a database. In this embodiment, the print identification data for the individual is obtained by a merchant from the individual using a wireless transceiver device and sent to the identity verification service by the merchant. Transaction data about the purchase is received by the credit service from the merchant. After processing the received data, the credit service sends data to the merchant about the individual's authorization to use a particular credit account to make the purchase. The data sent to the merchant by the credit card service is based, in part, on the data received from the identity verification service.

In embodiments of the invention, the print identification data is obtained from the individual using an identification device having a piezoelectric sensor. In an embodiment, the piezoelectric sensor includes a piezo ceramic sensor array. The invention is not limited, however, to using a piezo ceramic sensor array.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a wireless transceiver biometric device according to an embodiment of the invention.

FIG. 2 illustrates a more detailed view of the wireless transceiver biometric device of FIG. 1.

FIG. 3 illustrates a piezoelectric identification device according to an embodiment of the invention.

FIG. 4 illustrates circuit components of an identification device according to an embodiment of the invention.

FIG. 5 illustrates a wireless transceiver biometric device according to an embodiment of the invention.

FIG. 6 illustrates an example credit transaction according to an embodiment of the invention using the wireless transceiver biometric device of FIG. 1.

FIG. 7 illustrates a flowchart of a method for conducting a credit transaction according to an embodiment of the invention.

FIG. 8 illustrates example environments in which the wireless transceiver biometric device of FIG. 1 can be used to complete different types of transactions.

The present invention will now be described with reference to the accompanying drawings. In the drawings, like reference numbers indicate identical or functionally similar elements. Additionally, the leftmost digit(s) of a reference number identifies the drawing in which the reference number first appears.

### DETAILED DESCRIPTION OF THE INVENTION

I. Overview of the Invention

The present invention relates generally to new methods for conducting secure credit transactions. In embodiments, it relates to an identification device for obtaining biometric data or information, such as for a print, and using the obtained information to recognize and/or verify the identity of an individual. Print can be any type of print including, but not limited to, a print of all or part of one or more fingers, palms, toes, feet, hand, etc. A print can also be a rolled print, a flat print, or a slap print. The use of the term “data” or “information” throughout the specification can be representative of a biometric, a digital or other image of a biometric (e.g., a bitmap or other file), extracted digitally or other information relating to the biometric, etc.

The use of the term “match” or “matching” can be defined as the process of comparing a biometric sample against a previously stored template and scoring the level of similarity. Then, an accept or reject decision can be made based upon whether this score exceeds a predetermined threshold. Matching can be performed by comparing a party's print to one or more stored prints to either (1) determine if there is a match against the party's alleged identity or (2) a match against any stored print when there is no alleged identity.

The use of the term “verify” or “verification” can be defined as the process of comparing a submitted biometric sample against a biometric reference or template (e.g., data which represents a biometric measurement of an enrollee, used by a biometric system for comparison against subsequently submitted biometric samples) of a single enrollee whose identity is being claimed to determine whether the submitted biometric sample matches the enrollee's template.

The use of the term “identify” or “identification” can be defined as the one-to-many process of comparing a submitted biometric sample against all of the biometric reference templates on file to determine whether it matches any of the templates and, if so, the identity of the enrollee whose template was matched.

II. Wireless Transceiver Biometric Devices

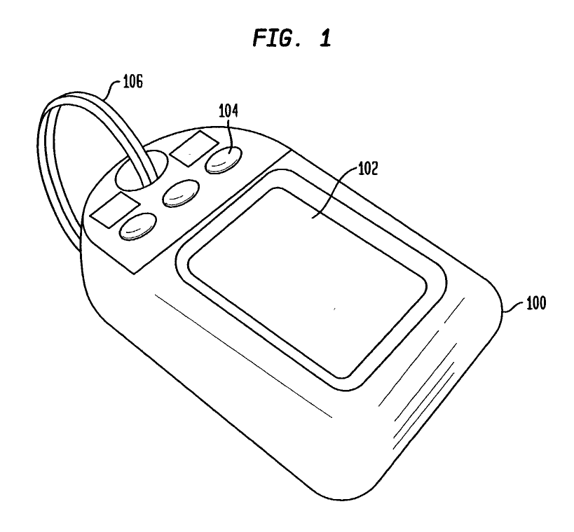

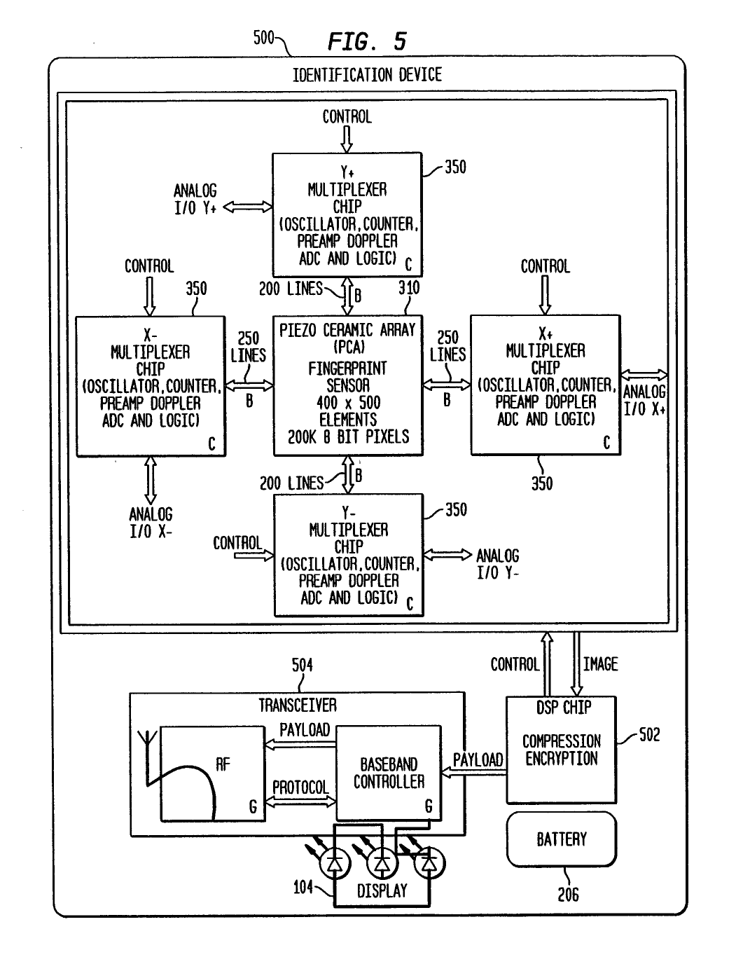

FIG. 1 illustrates a wireless transceiver biometric device 100 according to embodiments of the present invention. Device 100 is intended to be used by the general populace, for example, as an electronic signature device. Device 100 has a sensor 102 for obtaining biometric data (e.g., print data). In some embodiments, sensor 102 can be a piezo ceramic sensor or piezo electric thin film sensor. Device 100 can also have three indicator lights 104 for communicating information to a user. A key ring 106 can be attached to device 100. In same embodiments wireless transceiver biometric device 100 includes a BLUETOOTH wireless transceiver biometric device, as described further below with respect to FIG. 5.

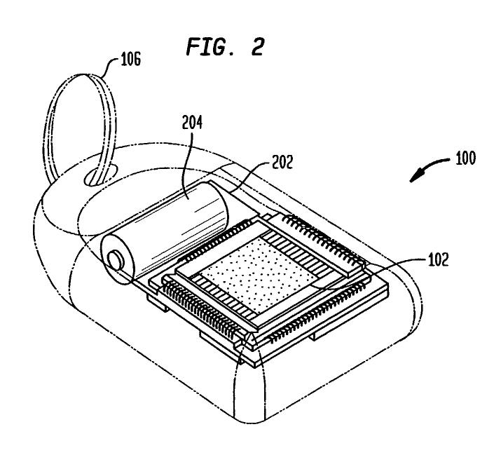

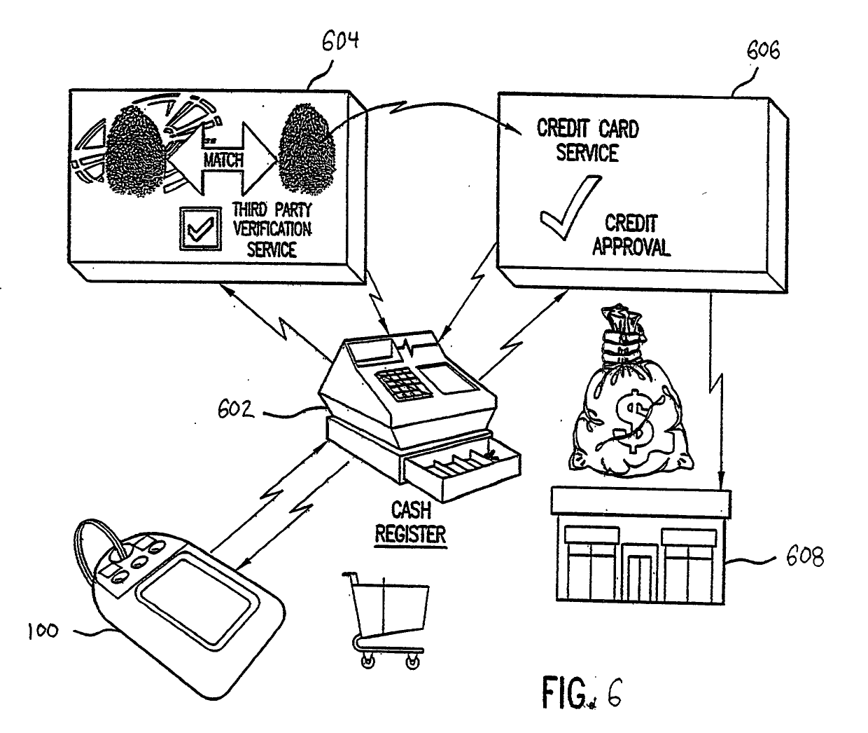

FIG. 2 illustrates a more detailed view of wireless transceiver biometric device 100 according to embodiments of the present invention. Device 100 has an antenna 202 that can be used for sending information to and receiving information from other devices. Sensor 102 is powered by a battery 204. In some embodiments, device 100 can be made to be compatible with BLUETOOTH wireless technology, as discussed above. Various uses of device 100 are described below in reference to FIGS. 6-8.

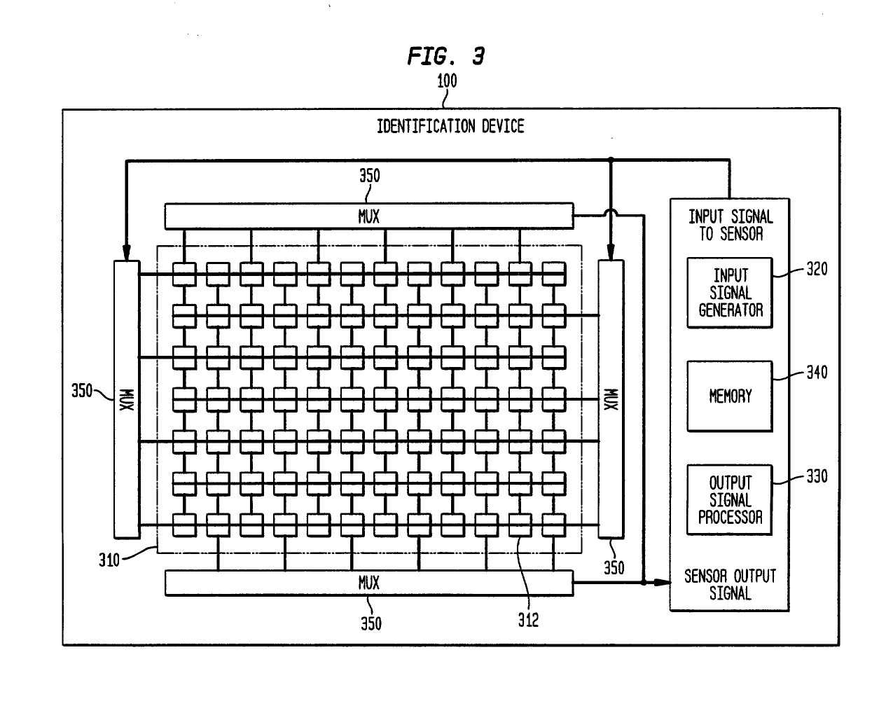

FIG. 3 is a schematic diagram of wireless transceiver biometric device 100 according to embodiments of the present invention. Identification device 100 has a piezoelectric sensor 310, a sensor input signal generator 320, a sensor output signal processor 330, and a memory 340. The input signal generated by input signal generator 320 is coupled to sensor 310 by two multiplexers 350. The output signal of sensor 310 is similarly coupled to output signal processor 330 by two multiplexers 350. In some embodiments, sensor 310 can be an array of piezo ceramic elements. In some embodiments, sensor 310 can include an array of polycrystalline ceramic elements that are chemically inert and immune to moisture and other atmospheric conditions. Polycrystalline ceramics can be manufactured to have specific desired physical, chemical, and/or piezoelectric characteristics. In other embodiments, sensor 310 can include a piezoelectric film (e.g., a polarized fluoropolymer film, such as polyvinylidene fluoride (PVDF) film or its copolymers can be used).

More detailed information on the elements and functions of the wireless transceiver biometric device can be found in the 60/330,794Prov. App, which is incorporated by reference herein in its entirety.

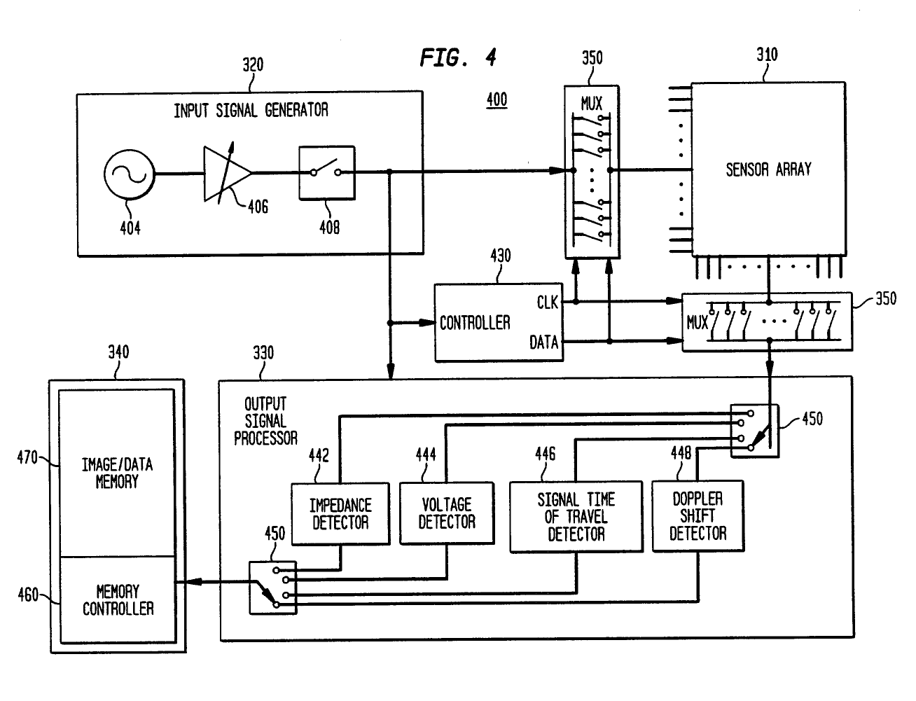

FIG. 4 illustrates an identification device 400 according to embodiments of the present invention. Device 400 includes an input signal generator 320, a sensor array 310, an output signal processor 330, a memory controller 460, and a memory 470. Sensor array 310 is coupled to input signal generator 320 and output signal processor 330 by multiplexers 350. A controller 430 controls the operation of multiplexers 350. The operation of identification device 400 is further described below.

In some embodiments, input signal generator 320 includes an input signal generator or oscillator 404, an variable amplifier 406, and a switch 408. In an embodiment, oscillator 404 produces a 20 MHz signal, which is amplified to either a low or a high voltage (e.g., about 4 volts or 8 volts) by variable amplifier 406, depending on the mode in which device 400 is operating. Switch 408 is used to provide either no input signal, a pulsed input signal, or a continuous wave input signal. Switch 408 is controlled to produce the various types of input signals described herein in a manner that would be known to a person skilled in the relevant art. The input signal generated by input signal generator 320 is provided to sensor array 310 via multiplexer 350, to controller 430, and to output signal processor 330. In an embodiment, sensor array 310 is a piezo ceramic composite of rectangular elements designed to operate with a 20 MHz input signal.

The output signal processor 330 includes various biometric detection devices, including an impedance detector 442, a voltage detector 444, a signal time of travel detector 446, and a doppler shift detector 448. Only one detector 442, 444, 446, or 448 is usually functioning during a period of time. Thus, switches 450 are used to coupled the functioning detector 442, 444, 446, or 448 to memory 340 and multiplexer 350. Further description of the operation of these detectors is found in U.S. Prov. App. 60/330,794, which is incorporated by reference herein in its entirety.

III. Example Applications

A. Overview of Applications

In some embodiments, one wireless transceiver biometric device 100 or 400 (e.g., BLUETOOTH device 500 with a piezo ceramic sensor as discussed below) can wirelessly communicate to different types of devices (e.g., computer mice, physical access control units, telephones, palm devices, set top boxes, computers, ATM machines, keyboards, locks, ignitions, etc.) to provide additional biometric-based security so that only an authorized person can operate the respective devices or gain a desired access or authorization. For example, wireless transceiver biometric device 100 or 400 (e.g., BLUETOOTH device 500 with a piezo ceramic sensor) can communicate over a piconet to a telephone to provide additional security so that only an authorized person can be operate the telephone. Similarly, wireless transceiver biometric device 100 or 400 can communicate to a remote control device to enhance security relating to the authorized use of set top boxes, televisions, recorders, players or other devices.

In other embodiments, a wireless transceiver biometric device 100 or 400 (e.g., BLUETOOTH device 500 with a piezo ceramic sensor) can be incorporated into any type of device where additional biometric security is desired. For example, wireless transceiver biometric device 100 or 400 can be incorporated in a telephone (not shown) to provide additional security so that only an authorized person can be operate the telephone. Similarly, wireless transceiver biometric device 100 or 400 can be built in a remote control device (not shown) to enhance security relating to the authorized use of set top boxes, televisions, recorders, players, or other devices.

In still other embodiments, device 100 or 400 can be used for: building access control; law enforcement; electronic commerce; financial transaction security; tracking employee time and attendance; controlling access to legal, personnel, and/or medical records; transportation security; e-mail signatures; controlling use of credit cards and ATM cards; file security; computer network security; alarm control; and identification, recognition, and verification of individuals.

In still other embodiments, wireless transceiver biometric device 100 or 400 is a low-cost, ubiquitous device that identifies a person and records the signature through both the print image and biological features such as blood flow. Information is transmitted to the other person(s) engaged in a transaction via a BLUETOOTH wireless network with other devices in the BLUETOOTH networks, such as a controller, a processor or computer (e.g., palm device, PDA, laptop, desktop, server, etc.), a set top box, a cellular telephone, a land-line telephone, and/or a vehicle (e.g., an automobile). Wireless transceiver biometric device 100 or 400 transmits authorization functions for physical access and alarm control, ignition control, computer and network access control, e-mail signatures, credit card transactions, cell phone identification, airline transactions, financial enrollment transactions, etc. via BLUETOOTH piconets.

In still other embodiments, wireless transceiver biometric device 100 or 400 can include a piezo ceramic sensor used for applications within many market segments including, but not limited to, financial, physical access control, automotive, telecommunications, computers, law and order, health care, immigration, and welfare markets. For example, in one financial market segment application, wireless transceiver biometric device 100 or 400 is used for physical access control for bank employees, cardholder verification and secure transaction certification. As another example, in one physical access control market segment application, wireless transceiver biometric device 100 or 400 can be used for automotive access and theft control, garage door, house access and activation of domestic security systems. As a still further example, in one automotive market segment application, wireless transceiver biometric device 100 or 400 can be used as an access and ignition control device. As a still further example, in one computer market segment application, wireless transceiver biometric device 100 or 400 can interact in a biometric device for network access control.

In still other embodiments, in one telecommunications market segment application, wireless transceiver biometric device 100 or 400 can be incorporated in a telephone. A wireless telephone or land-line telephone incorporates at least a sensor array, such as, a piezo ceramic sensor array or piezo electric thin film sensor array according to embodiments of the present invention. Communication and digital signal processor (DSP) functions can be carried out by the other components in the telephone. In other embodiments, BLUETOOTH is incorporated into both cellular and fixed station telephones for proximal communications. The telephone is then a flexible portal that the consumer will use to assert biometric authorizations and/or identifications according embodiments of the present invention.

These are just a few of the many useful applications of device 100 or 400 in particular, and the present invention in general. Additional applications for device 100 or 400 and the invention will be apparent to those skilled in the relevant arts given the description of the invention herein.

B. Personal Area Network Applications

FIG. 5 illustrates a wireless transceiver biometric device 500 according to embodiments of the present invention. As described herein, embodiments of the invention are capable of interacting with other devices as part of a personal area network. Device 500 includes a biometric device (labeled as an identification device), which is similar to device 400,and which includes a DSP chip 502, a BLUETOOTH chip 504, a display (which can be similar to 104), and a battery 206. The identification device can have a piezo ceramic sensor array 310 and four multiplexers 350, according to embodiments of the invention. The identification device is coupled to DSP 502. DSP 502 controls the identification device and stores biometric data. DSP 502 is also coupled to BLUETOOTH chip 504 for sending and receiving data. The display is used to communicate information to a user of device 500. Device 500 is powered by battery 206.

As would be known to a person skilled in the relevant art, BLUETOOTH is an agreement that governs the protocols and hardware for a short-range wireless communications technology. The invention is not limited to implementing only the BLUETOOTH technology. Other wireless protocols and hardware can also be used.

With continuing reference to FIG. 5, device 500 allows an individual to be in communication with compatible devices within about 30 feet of device 500. Device 500 can connect, for example, with telephones, cell phones, personal computers, printers, gas pumps, cash registers, Automated teller machines, door locks, automobiles, set top boxes, etc (none shown). Device 500 is able to supply a standardized secure identification or authorization token to any device, or for any process or transaction that needs or requests it. This is because device 500 can connect to and exchange information or data with any compatible device within a personal area network or piconet.

C. Credit Transactions and/or Electronic Sales Applications

FIG. 6 illustrates using the wireless transceiver biometric device 100 (only 100 is discussed, although device 400 or 500 could also be used) to complete an electronic sales transaction, or any other type of transaction, according to embodiments of the present invention. In some embodiments, device 100 is used to obtain biometric information such as a fingerprint from the individual (not shown) wanting to make a purchase. Device 100 then transmits the biometric information or fingerprint to a device coupled to cash register 602, which sends the biometric information or fingerprint to an identity verification service such as, for example, third party verification service 604. The third party verification service 604 uses the received biometric information or fingerprint to verify the identity of the purchaser by matching the received biometric information or fingerprint to data stored in a database. The identity of the purchaser can then be sent to cash register 602 and to a credit card service 606. The credit card service uses the data from the third party verification service to approve sales information received from cash register 602 and to prevent the unauthorized use of a credit card (not shown). Once cash register 602 receives verification of the purchaser's identity and verification that the purchaser is authorized to use the credit card service, cash register 602 can notify device 100 to send a credit card number. Cash register 602 can then send the credit card number to the credit card service 606, which transfers money to the sellers bank account to complete the sales transaction. These steps are illustrative of how device 100 can be used as an electronic signature device, and are not intended to limit the present invention.

In other embodiments for reducing or preventing credit card fraud, wireless transceiver biometric device 100 contains the credit card transaction information that the store requires for a purchase. This data is transmitted to the cash register 602 via a BLUETOOTH piconet or other communications system. First, the biological information or fingerprint(s) are transmitted via a piconet and Internet to a third party for approval of the transaction, then the credit card transaction information flows from device 100 to the store and the credit card company in the normal way. The third party's function is to guarantee the purchaser's identity in a transaction to the credit card company, thereby, reducing or eliminating the possibility of fraud.

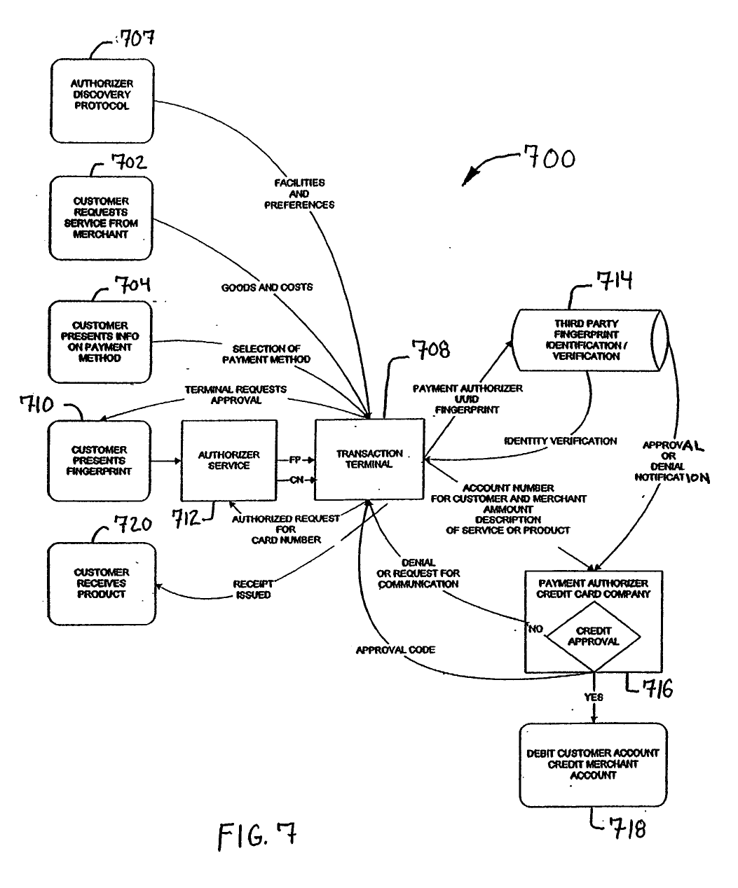

FIG. 7 illustrates a process 700 for using an authorizer service 712 to complete an electronic sales transaction using a credit card number or credit account number, according to an embodiment of the present invention. As used herein, authorizer service 712 comprises an identification device (e.g., device 100, 400, or 500) together with a credit card number or credit account number.

Process 700 begins in step 702 with a customer who wants to make a credit transaction or purchase with a merchant. In step 704, the customer presents a payment method. This payment method can be, for example, payment using a credit card or debit card or some other type of credit account. The payment method in step 704 is presented to a transaction terminal 708, or the merchant who operates the transaction terminal 708.

In step 707, communications are established between the transaction terminal 708 and the identification device of the authorizer service 712. In embodiments of the present invention, communications are established via a piconet wireless communications system, via a BLUETOOTH compliant wireless communications system, or via an IEEE 802.11 compliant wireless communications system. Other wireless or plug-in communications systems can also be used however. In an embodiment, the transaction terminal 708 receives a discovery protocol from the identification device of authorizer service 712. This discovery protocol involves transmitting and/or receiving typical information required to synchronize two or more communications devices. Optionally, this discovery protocol may also include additional information about the individual stored in a memory of the identification device.

In step 710, the customer presents or provides print identification data to the transaction terminal 708. In embodiments, step 710 involves using the identification device of the authorizer service 712 to capture and process the print identification data and to send the print identification data to the transaction terminal 708. The print data sent to and received by transaction terminal 708 can include, for example, fingerprint data, minutiae data, or data for a finger or a thumb of the individual wanting to make the credit transaction or purchase.

After the print identification data is received at transaction terminal 708, it is sent by transaction terminal 708 to an identity verification service such as third party fingerprint identification/verification service 714. The identity verification service uses the print identification data to make a determination about the customer's or individual's identity. In embodiments, this determination is made by comparing and matching the received print identification data to data stored in a database. In embodiments, for example, a fingerprint (minutiae or image data) received from a customer is matched to a fingerprint (minutiae or image data) stored in a fingerprint database. The identity verification service (e.g., third party fingerprint identification/verification service 714) sends the result of its determination (identity data) either to transaction terminal 708, or to a payment approval service (e.g., payment authorizer or credit card company 716) or to both.

As illustrated in FIG. 7, a credit account number or a credit card to be used to make a purchase is provided by the customer. In embodiments, this credit account number is stored in a memory of the authorizer service 712 and sent or communicated to the transaction terminal 708 by the authorizer service 712. Transaction terminal 708 sends the credit account number or credit card number, along with other data about the purchase (e.g., the purchase price) to a payment approval service such as, for example, payment authorizer or credit card company 716. The credit account number and other data can be sent to the payment approval service either before or after the identity data from the identity verification service is received at transaction terminal 708. The payment approval service uses the data received from the transaction terminal 708 and the identity verification service (if provided) to approve purchases and to prevent the unauthorized use of the credit account number or credit card. The payment approval service sends the result of its approval determination (authorization data) to the transaction terminal 708. In embodiments, in step 718, if the payment approval service approves the purchase, money is debited from the purchaser's account and credited to the merchant's account.

After receiving the verification data and the authorization data, the merchant makes a determination whether to complete the purchase. If the merchant decides to complete the purchase, the customer receives the purchased product and a receipt in step 720.

The steps of process 700 described herein are illustrative of the operation of an embodiment of the present invention, and are not intended to limit the present invention. Process 700 has been described primarily with respect to a fingerprint, however, the invention is not so limited and can be used with any type of print or biometric feature, or combinations of prints or biometric features.

D. Additional Wireless Transceiver Biometric Device Applications

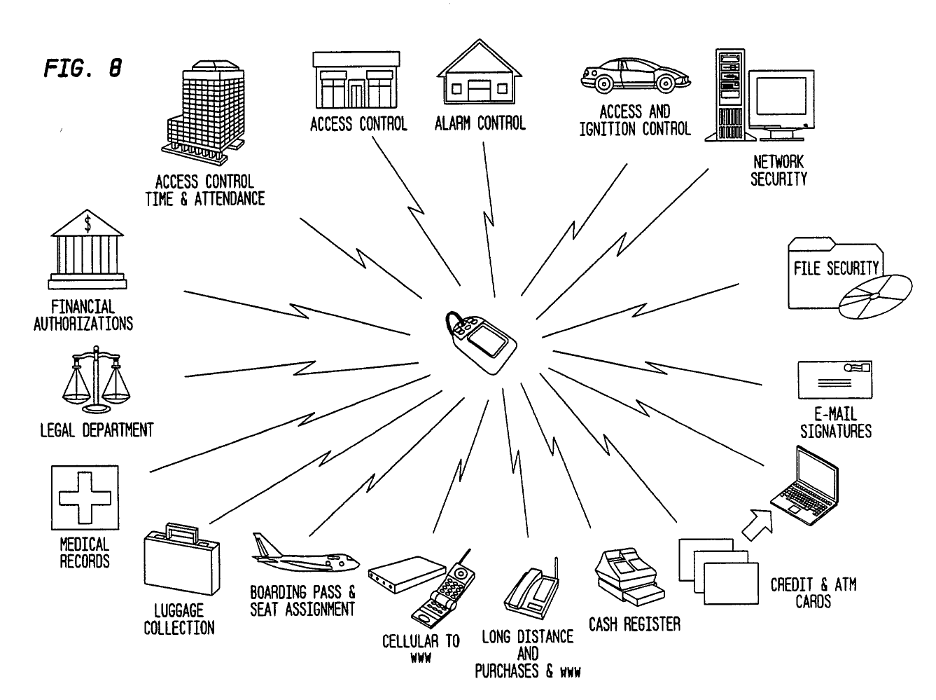

FIG. 8 illustrates additional applications for which the wireless transceiver biometric device 100 is well suited. For example, device 100 can be used for: building access control; law enforcement; electronic commerce; financial transaction security; tracking employee time and attendance; controlling access to legal, personnel, and/or medical records; transportation security; e-mail signatures; controlling use of credit cards and ATM cards; file security; computer network security; alarm control; and identification, recognition, and verification of individuals.

In embodiments, wireless transceiver biometric device 100 is a low-cost, easy to use, ubiquitous device that identifies a person. The device acts as an electronic signature device that records the signature through biometric information such as a fingerprint image. Information is transmitted to the other person(s) engaged in a transaction via a wireless and/or wired network. The device is compatible with other networked devices such as any type of processor or computer (palm device, PDA, laptop, desktop, server, etc.), set top box, cellular telephone, landline telephone, and/or vehicle (such as an automobile). Wireless transceiver biometric device 100 transmits authorization functions for physical access and alarm control, ignition control, computer and network access control, e-mail signatures, cell phone identification, airline transactions and financial enrollment transactions via wireless and/or wired networks as indicated in FIG. 8.

Wireless transceiver biometric device 100 including an embodiment with a piezoceramic sensor that has applications within many market segments including but not limited to financial, physical access control, automotive, telecommunications, computers, law and order, health care, immigration and welfare markets. For example, in one financial market segment application, wireless transceiver biometric device 100 is used for physical access control for bank employees, cardholder verification and secure transaction certification. In one physical access control market segment application, wireless transceiver biometric device 100 is used for automotive access and theft control, garage door, house access and activation of domestic security systems. In one automotive market segment application, wireless transceiver biometric device 100 is used as an access and ignition control device. In one computer market segment application, wireless transceiver biometric device 100 is used as a biometric device for network access control.

Finally, in one telecommunications market segment application, wireless transceiver biometric device 100 is incorporated in a telephone. A wireless telephone or landline telephone incorporates at least a sensor array, such as, a piezo ceramic sensor array or piezo electric thin film sensor array according to embodiments of the present invention. In this application, communication and DSP functions can be carried out by the other components in the telephone. The telephone is then a flexible portal that the consumer will use to assert biometric authorizations and/or identifications according to the present invention.

In certain embodiments, one wireless transceiver biometric device 100 can wirelessly communicate to different types of devices (e.g., computer mice, physical access control units, telephones, palm devices, set top boxes, computers, ATM machines, keyboards, locks, ignitions, etc.) to provide additional biometric-based security so that only an authorized person can operate the respective devices or gain a desired access or authorization. For example, wireless transceiver biometric device 100 can communicate over a piconet to a telephone to provide additional security so that only an authorized person can operate the telephone. Similarly, wireless transceiver biometric device 100 can communicate to a remote control device to enhance security relating to the authorized use of set top boxes, televisions, recorders, players or other devices.

These are just a few of the many useful application of device 100 in particular, and the present invention in general. Additional applications for device 100 and the invention will become apparent to those skilled in the relevant arts given the description of the invention herein.

Compatibility Feature

As described above, embodiments of the invention are capable of interacting with other devices as part of a personal area network. The personal identification device of the invention can be implemented to communicate with other devices using any known wireless communications system or protocol, such as BLUETOOTH and/or IEEE 802.11.

Conclusion

While various embodiments of the present invention have been described above, it should be understood that they have been presented by way of example only, and not limitation. It will be understood by those skilled in the art that various changes in form and details can be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A method for conducting secure credit transactions, comprising:
(1) establishing communications between an identification device and a transaction terminal;
(2) receiving, at the transaction terminal from the identification device, print identification data for an individual wanting to make a purchase using credit, the print identification data having been obtained from the individual using the identification device;
(3) sending the print identification data received at the transaction terminal to an identity verification service for a determination of the individual's identity, the determination being based on a comparison of the print identification data to data stored in a database;
(4) receiving, at the transaction terminal from the identification device, a credit account number to be used to make the purchase;
(5) sending the credit account number received at the transaction terminal and information about the purchase to a payment approval service;
(6) receiving, at the transaction terminal, verification data about the individual's identity and authorization data about the individual's ability to pay for the purchase using credit; and
(7) making a determination whether to complete the purchase based on the received verification data and the received authorization data.

2. The method of claim 1, wherein step (1) comprises establishing communications via a piconet wireless communications system.

3. The method of claim 1, wherein step (1) comprises establishing communications via a BLUETOOTH compliant wireless communications system.

4. The method of claim 1, wherein step (1) comprises establishing communications via an IEEE 802.11 compliant wireless communications system.

5. The method of claim 1, wherein step (2) comprises receiving fingerprint data.

6. The method of claim 5, wherein step (2) comprises receiving minutiae data.

7. The method of claim 5, wherein step (2) comprises receiving data for a thumb of the individual.

8. The method of claim 1, wherein the identification device is a wireless transceiver biometric device.

9. The method of claim 1, wherein step (4) comprises receiving a credit card number.

10. The method of claim 1, wherein step (6) comprises receiving the verification data from the identity verification service.

11. The method of claim 1, wherein step (6) comprises receiving the authorization data from the payment approval service.

12. The method of claim 1, wherein step (6) comprises receiving the verification data and the authorization data from the payment approval service.

13. A method for conducting secure credit transactions, comprising:
(1) receiving, at a transaction terminal from an identification device, print identification data for an individual wanting to make a purchase using credit, the print identification data having been obtained from the individual using the identification device;
(2) sending the print identification data received at the transaction terminal to an identity verification service for a determination of the individual's identity, the determination being based on a comparison of the print identification data to data stored in a database;
(3) receiving, at the transaction terminal from the identity verification service, verification data about the individual's identity;
(4) if the verification data indicates the individual's identity has been verified, sending a request for a credit account number from the transaction terminal to the identification device;
(5) receiving, at the transaction terminal from the identification device, a credit account number to be used to make the purchase;
(6) sending the credit account number received at the transaction terminal and information about the purchase to a payment approval service;
(7) receiving, at the transaction terminal, authorization data from the payment approval service about the individual's ability to pay for the purchase using credit; and
(8) making a determination whether to complete the purchase based on the received verification data and the received authorization data.

14. The method of claim 13, wherein step (1) comprises receiving fingerprint data.

15. The method of claim 14, wherein step (1) comprises receiving minutiae data.

16. The method of claim 14, wherein step (1) comprises receiving data for a thumb of the individual.

17. The method of claim 13, wherein the identification device is a wireless transceiver biometric device.

18. The method of claim 13, wherein step (5) comprises receiving a credit card number.

19. The method of claim 13, further comprising:
(9) establishing communications between the identification device and the transaction terminal.

20. The method of claim 19, wherein step (9) comprises establishing communications via a piconet wireless communications system.
